(19) United States
(12) Patent Application Publication
(10) Pub. No.: US 2026/0352710 A1
(43) Pub. Date: Nov. 5, 2026

(54) Digital Twin for Network Resilience

(71) Applicant: Bank of America Corporation, Charlotte, NC (US)

(72) Inventors: Benjamin Pavalon, Chicago, IL (US); Benjamin F. Tweel, Romeoville, IL (US)

(21) Appl. No.: 19/198,320

(22) Filed: May 5, 2025

(51) Int. Cl. H04L 9/40; H04L 41/14

(52) U.S. Cl. CPC H04L 63/1491; H04L 41/145; H04L 63/1458

(57) ABSTRACT

Arrangements for generating and using a digital twin for network or system resilience and testing are provided. A computing platform having at least one processor and memory may capture or receive data from an enterprise system or network. The computing platform may generate a digital twin of the enterprise system or network that is a virtualized replica of the enterprise system or network. Additional, real-time data of the enterprise network or system may be received or captured by the computing platform. The computing platform may continuously synchronize the digital twin with the enterprise system or network based on the captured or received additional, real-time data. At a predetermined time, the computing platform may capture a snapshot of the digital twin and store the snapshot. Upon detection of a failure of the enterprise system or network, the snapshot may be retrieved and used to restore the enterprise system or network.

### BACKGROUND

Aspects of the disclosure relate to electrical computers, systems, and devices for generating a digital twin to promote network and system resilience.

Enterprise organizations implement a variety of complex, dynamic systems and networks that are critical for daily operation. However, ensuring network or system security, resilience and performance remains a significant challenge, as testing and evaluating defenses on live systems can disrupt operations, introduce new risk and expose vulnerabilities. Conventional testing methods lack an isolated, real-time replica that can be used to simulate attacks, validate updates and/or measure resilience under stress. Accordingly, it would be advantageous to provide a virtualized, synchronized replica of the network or system in order to securely test updates and maintain network or system resilience.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical issues associated with securely testing system or network updates and maintaining network or system resilience.

In some examples, a computing platform having at least one processor and memory may capture or receive data from an enterprise system or network. The computing platform may generate a digital twin of the enterprise system or network that is a virtualized replica of the enterprise system or network. In some examples, additional, real-time data of the enterprise network or system may be received or captured by the computing platform. In some examples, the computing platform may continuously synchronize the digital twin with the enterprise system or network based on the captured or received additional, real-time data.

In some arrangements, at a predetermined time, the computing platform may capture a snapshot of the digital twin and store the snapshot. Upon detection of a failure of the enterprise system or network, the snapshot may be retrieved and used to restore the enterprise system or network.

In some examples, the computing platform may generate a honeypot based on the digital twin. Upon detecting unauthorized access to the digital twin (e.g., via the honeypot), the computing platform may capture data related to the unauthorized user accessing the digital twin.

In some examples, one or more testing processes may be executed by the digital twin. For instance, testing of new firewall rules or instruction prevention system updates may be performed. Additionally or alternatively, simulated cyberattacks may be executed on the digital twin to measure or validate a response of the enterprise network or system based on testing outputs from the simulated attacks on the digital twin.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for generating and using a digital twin for network or system resilience in accordance with one or more aspects described herein;

FIGS. 2A-2D depict an illustrative event sequence for generating and using a digital twin for network or system resilience in accordance with one or more aspects described herein;

FIG. 3 illustrates an illustrative method for generating and using a digital twin for network or system resilience according to one or more aspects described herein;

FIG. 4 illustrates an example user interface that may be generated in accordance with one or more aspects described herein; and

FIG. 5 illustrates one example environment in which various aspects of the disclosure may be implemented in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed above, enterprise organizations employ complex, dynamic systems that are critical to daily operations. However, maintaining network or system security, resilience and performance may be significant challenge for the enterprise organization. Accordingly, aspects described herein are directed to a digital twin including a virtualized replica of the enterprise network or system for use in testing, system recovery, and the like. The digital twin may mirror the live environment in real-time, enabling enterprise organizations to test network defenses, simulate cyberattacks, and measure performance without impacting operations. The arrangements described may allow enterprise organizations to safely validate network updates, evaluate security measures and identifying vulnerabilities by running simulations in an isolated digital twin.

In some examples, a digital twin may be generated based on data captured or received from the enterprise network or system. After generating the digital twin, additional data may be captured or received from the enterprise network or system, in real-time, and may be used to continuously synchronize the digital twin with the enterprise network or system. In some examples, a snapshot of the digital twin may be captured at predetermined times and stored for use in restoring the enterprise system or network in case of failure. Additionally or alternatively, the digital twin may be used for testing changes to the enterprise system or network, simulating cyberattacks to measure response, and acting as honeypot to lure unauthorized actors to the digital twin in order to capture information about the unauthorized actors.

These and various other arrangements will be discussed more fully below.

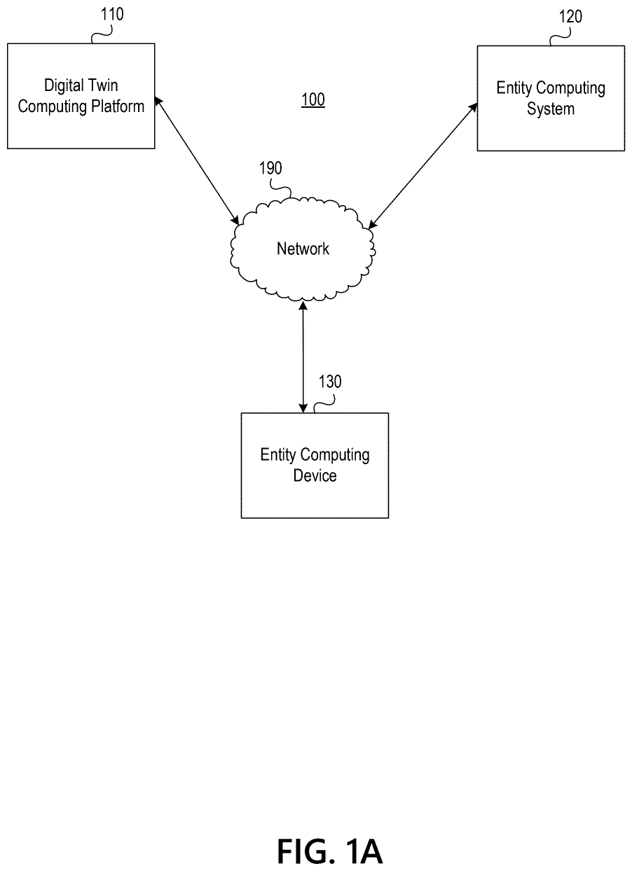

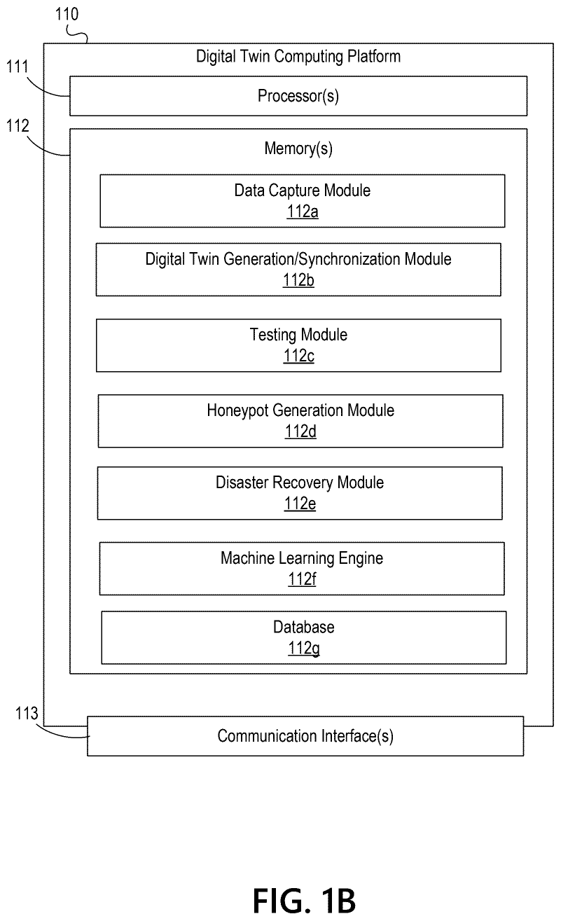

FIGS. 1A-1B depict an illustrative computing environment and devices for creating and using a digital twin for network and system testing and resilience in accordance with one or more aspects described herein. Referring to FIG. 1A, computing environment 100 may include one or more computing devices and/or other computing systems. For example, computing environment 100 may include digital twin computing platform 110, entity computing system 120, and/or entity computing device 130.

Although one entity computing system 120 and one entity computing device 130 are shown, any number of devices and systems may be used without departing from the invention.

Digital twin computing platform 110 may be or include one or more computer components (e.g., servers, server blade, processor, memory, and the like) and may be configured to perform intelligent, dynamic, real-time generation and maintenance of a digital twin of an entity network or system, such as entity computing system 120. For instance, digital twin computing platform 110 may capture, from one or more enterprise organization networks or systems, real-time data of the network or system. Based on the capture data, digital twin computing platform 110 may generate a digital twin of a corresponding network or system. The digital twin may be an isolated, real-time, virtualized replica of the corresponding network or system and may be used to simulate attacks, test defenses, evaluate impact of configuration changes, and the like. Additionally or alternatively, the digital twin may be used to generate a honeypot to lure threat actors in to the digital twin environment in order to capture information about the threat actors. Further, the digital twin may provide disaster recovery assistance. For instance, snapshots of the digital twin may be captured at various points in time and stored (e.g., for a predetermined time, until overwritten with later captured snapshots, or the like). The snapshots may be used to recreate the network or system should an issue arise.

In addition, the digital twin may include or integrate with one or more artificial intelligence or machine learning tools in order to generate predictive insights into potential weaknesses or vulnerabilities, bottlenecks, emerging risks, and may enable proactive threat management and/or network or system optimization.

Entity computing system 120 may be or include one or more enterprise organization systems, networks, or the like, that may provide the basis for the digital twin. Entity computing system 120 may be or include one or more servers, server blades, processors, memory, and the like and may be configured to host or execute one or more enterprise organization applications, systems, networks, or the like. Entity computing system 120 may be used by users of the enterprise organization (e.g., employees, customers, and the like) throughout the course of business and data associated with the entity computing system 120 may be captured continuously or near continuously and in real-time in order to generate, update, synchronize, or the like, the digital twin of the entity computing system 120.

Entity computing device 130 may be or include one or more computers or computer components (e.g., processors, memory, desktop devices, laptop devices, smart phones, smart watches, wearable devices, tablets, and the like) and may be configured to connect to and/or communicate with digital twin computing platform 110 and/or entity computing system 120. Entity computing device 130 may be operated by a user of the enterprise organization (e.g., an employee, system administrator, or the like) to receive notifications related to the digital twin (e.g., detected threat actors, captured threat actor data, test or simulation results, and the like). Entity computing device 130 may be configured to display one or more user interfaces, dashboards, or the like, in order to display data related to the digital twin and/or a corresponding network or system, such as entity computing system 120.

As mentioned above, computing environment 100 also may include one or more networks, which may interconnect one or more of digital twin computing platform 110, entity computing system 120, and/or entity computing device 130. For example, computing environment 100 may include network 190. Network 190 may, in some examples, be a private network and include one or more sub-networks (e.g., Local Area Networks (LANs), Wide Area Networks (WANs), or the like). In some examples, network 190 may be a public network or may include a public network and private network in communication with each other. Network 190 may interconnect one or more computing devices associated with the organization and/or external to the organization. For example, digital twin computing platform 110, entity computing system 120, and/or entity computing device 130 may be connected via network 190.

Referring to FIG. 1B, digital twin computing platform 110 may include one or more processors 111, memory 112, and communication interface 113. A data bus may interconnect processor(s) 111, memory 112, and communication interface 113. Communication interface 113 may be a network interface configured to support communication between digital twin computing platform 110 and one or more networks (e.g., network 190, or the like). Memory 112 may include one or more program modules having instructions that when executed by processor(s) 111 cause digital twin computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of digital twin computing platform 110 and/or by different computing devices that may form and/or otherwise make up digital twin computing platform 110.

For example, memory 112 may have, store and/or include data capture module 112a. Data capture module 112a may store instructions and/or data that may cause or enable the digital twin computing platform 110 to capture data for a particular network, system or the like, such as entity computing system 120. In some examples, the data may be captured in real-time or near real-time on a continuous or near continuous basis.

Digital twin computing platform 110 may further have, store and/or include digital twin generation/synchronization module 112b. Digital twin generation/synchronization module 112b may store instructions and/or data that may cause or enable digital twin computing platform 110 to generate a digital twin of an enterprise network or system, such as entity computing system 120, based on data captured by data capture module 112a. The digital twin may be a virtualized replica of, for instance, the entity computing system 120, and may be isolated in order to enable controlled testing of the system and/or configuration changes, controlled analysis of threat actors responding to a honeypot, and the like. Digital twin generation/synchronization module 112b may further store instructions that may cause the digital twin computing platform 110 to synchronize or otherwise update a generated digital twin based on subsequently captured data. Accordingly, the digital twin may be maintained, in real-time or near real-time, as a replica of the entity computing system 120 in order to ensure accuracy of any processes run by the digital twin, to ensure resilience, to enable disaster recovery, and the like.

Digital twin computing platform 110 may further have, store and/or include testing module 112c. Testing module 112c may store instructions and/or data that may cause or enable the digital twin computing platform 110 to execute one or more tests or testing scenarios on the digital twin (e.g., in an isolated environment where the testing will not impact live or deployed systems or networks). For instance, testing module 112c may simulate attacks, configuration changes, and the like, and may measure the impact of the attacks or changes in a secure, sandbox environment. Testing via the digital twin may also minimize disruptions to live systems during the testing process, reducing risk and improving preparedness.

Digital twin computing platform 110 may further have, store and/or include honeypot generation module 112d. Honeypot generation module 112d may store instructions and/or data that may cause or enable the digital twin computing platform 110 to generate a honeypot or other lure for unauthorized actors to attempt to access the system or network, such as entity computing system 120. The honeypot generation module 112d may, in some examples, include the digital twin but may also include false data that may appear to be authenticate date in order to lure the unauthorized actors in. Once an unauthorized actor accesses the digital twin based on the honeypot, honeypot generation module 112d may capture data related to the unauthorized actor (e.g., techniques used to access the system, type of data search or downloaded, internet protocol (IP) address of the unauthorized actor, and the like) in order to track the unauthorized users, learn about current techniques for unauthorized access that are being used, develop mitigation actions to thwart the unauthorized actors, and the like.

Digital twin computing platform 110 may further have, store and/or include disaster recovery module 112e. Disaster recovery module 112e may store instructions and/or data that may cause or enable the digital twin computing platform 110 to capture and store snapshots of the digital twin at various time or on a predetermined schedule (e.g., every 8 hours, once per day, or the like). These snapshots may then be retrieved and used to rebuild a system in case of system failure or other catastrophic issue. Accordingly, the digital twin may maintain a current, virtualized replica of the system and snapshots of that replica may be captured and used to restore the system as needed.

Digital twin computing platform 110 may further have, store and/or include machine learning engine 112f. Machine learning engine 112f may store instructions and/or data that may cause or enable the digital twin computing platform 110 to train, execute, update and/or validate one or more machine learning models. For instance, machine learning engine 112f may be trained using historical data related to system issues, performance bottlenecks, threats, and/or performance optimization in order to generate one or more insights related to these aspects in subsequent data. For instance, one or more stored correlations may be identified from the historical data based on relationships between system performance characteristics and optimization, system characteristics associated with poor performance, issues or slow downs in the system, historical threats, and the like. Machine leaning model may then receive subsequent data captured by or used to generate or synchronize the digital twin as inputs and may output one or more insights, recommendations or the like, related to performance of the system.

Digital twin computing platform 110 may further have, store and/or include database 112g. Database 112g may store data related to historical performance of the system, data captured to generate or update the digital twin, generated insights from the machine learning model, unauthorized actor data based on generated honeypots, snapshots of the digital twin for use in disaster recovery, and/or any other data to perform the functions of digital twin computing platform 110.

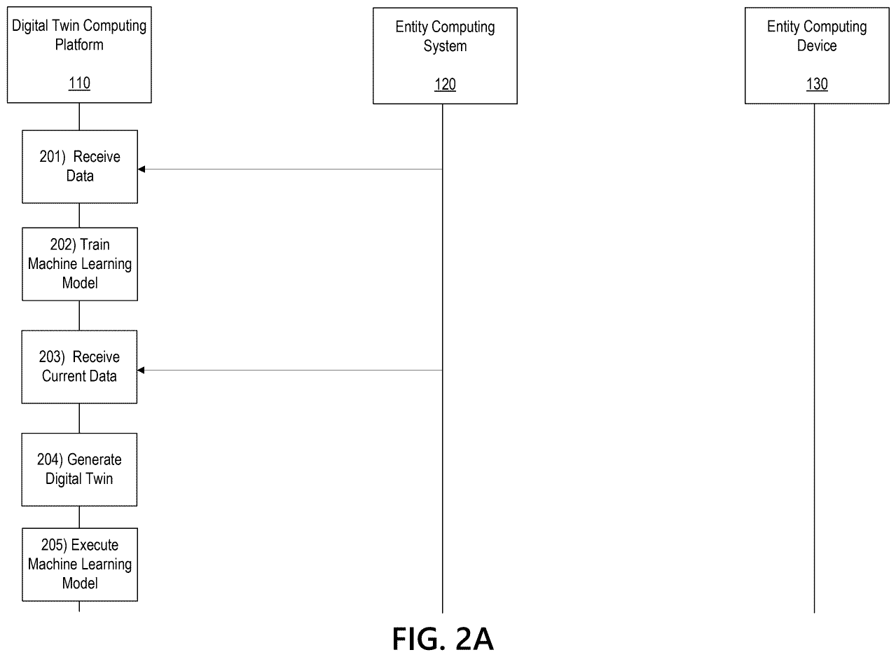

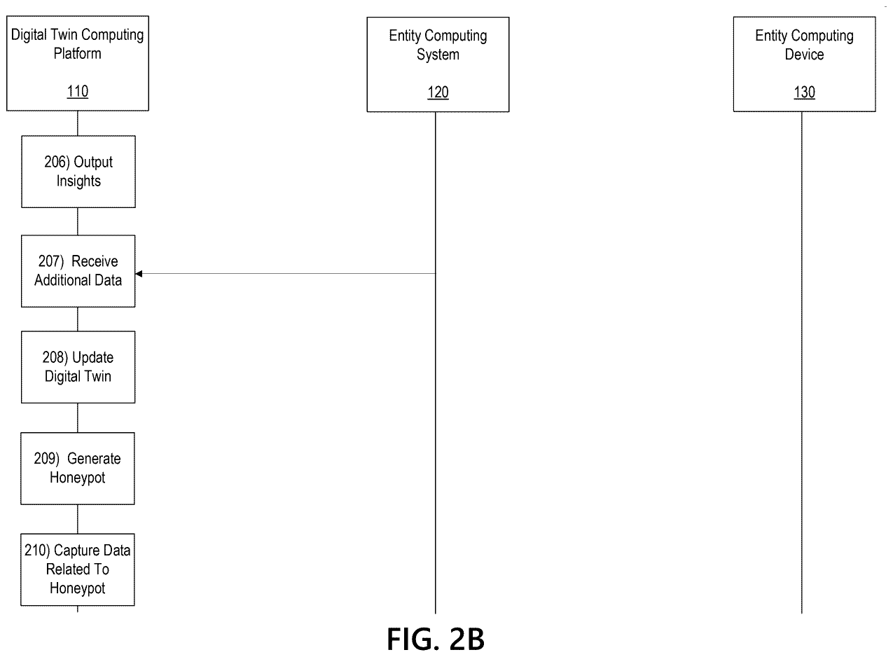

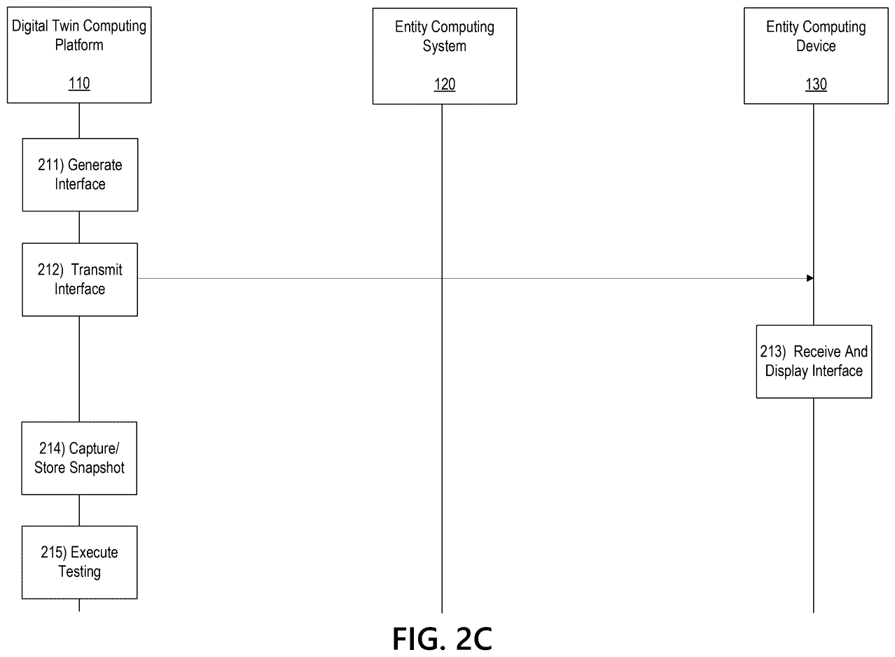

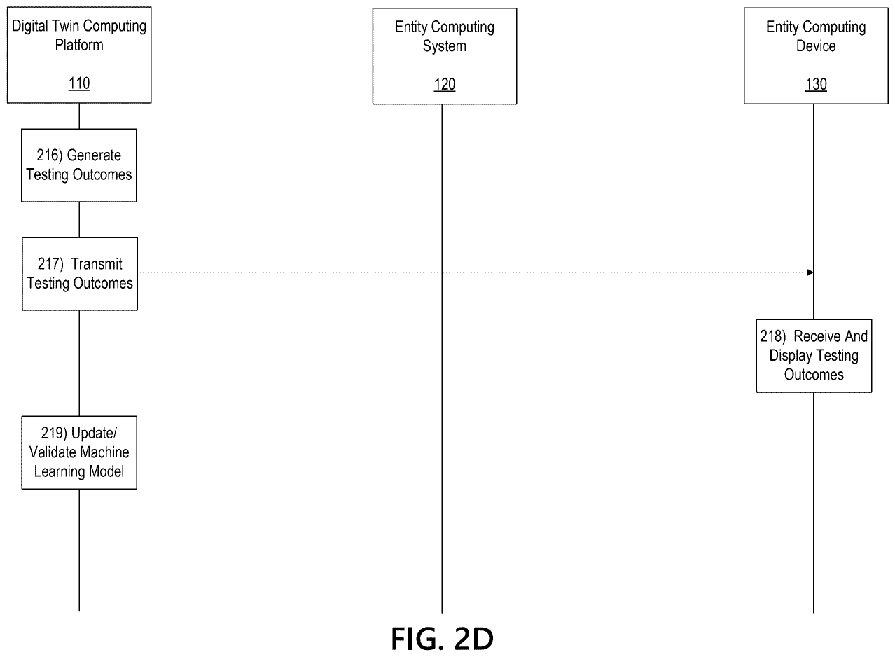

FIGS. 2A-2D depict one example illustrative event sequence for generating a digital twin to provide network resilience in accordance with one or more aspects described herein. The events shown in the illustrative event sequence are merely one example sequence and additional events may be added, or events may be omitted, without departing from the invention. Further, one or more processes discussed with respect to FIGS. 2A-2D may be performed in real-time or near real-time.

With reference to FIG. 2A, at step 201, digital twin computing platform 110 may receive data from one or more systems, networks, and the like, such as entity computing system 120. The data may include historical data related to network or system issues, performance metrics, unauthorized access or attacks, known cyberthreats, known system or network vulnerabilities, and the like.

At step 202, digital twin computing platform 110 may train a machine learning model. For instance, the data received at step 201 may be used to train the machine learning model to identify correlations, patterns or sequences in data in order to output insights or predictions related to the system or network. For instance, the historical data may be used to train the model to identify correlations between certain performance metrics of a system or network and a level of performance (e.g., optimized, slow, poor, or the like). In another example, the historical data may be used to train the model to identify correlations between features of a system or network and known vulnerabilities or cyber threats. Various other correlations may be identified and stored by the machine learning model without departing from the invention.

In some examples, training the machine learning model may include using one or more supervised learning techniques (e.g., decision trees, bagging, boosting, random forest, k-NN, linear regression, artificial neural networks, support vector machines, and/or other supervised learning techniques), self-supervised learning techniques (e.g., autoassociative self-supervised learning, contrastive self-supervised learning, non-contrastive self-supervised learning, or the like), unsupervised learning techniques (e.g., classification, regression, clustering, anomaly detection, artificial neutral networks, and/or other unsupervised models/techniques), and/or other techniques.

At step 203, digital twin computing platform 110 may receive current or real-time data from a network or system, such as entity computing system 120. The data may include current performance data, applications executing on or hosted by the system, devices associated with the system, and the like.

At step 204, digital twin computing platform may generate, based on the current or real-time data received at step 203, a digital twin of the network or system, such as entity computing system 120. The digital twin may be a virtual representation or replica of the entity computing system 120 and may virtualize all aspects of the entity computing system 120. The generated digital twin may be stored by digital twin computing platform 110.

At step 205, digital twin computing platform 110 may execute the machine learning model. For instance, the real-time data received at step 203 may be input to the machine learning model and the model may be executed to output, at step 206 in FIG. 2B, one or more insights or predictions related to the entity computing system 120. For instance, one or more vulnerabilities, potential cyber threats, recommendations for system or network optimization, identified performance issues, configuration inefficiencies, potential risks, attack vectors, and the like, may be output by the machine learning model based on the real-time data.

At step 207, digital twin computing platform 110 may receive additional or subsequent real-time data (e.g., real-time data captured at a time after the real-time data received at step 203). The real-time data may include the same or similar types of data as received at step 203 but at a later point in time, representing the current real-time conditions of entity computing system 120.

At step 208, digital twin computing platform 110 may update and/or synchronize the digital twin based on the real-time data received at step 207. Accordingly, the digital twin may be maintained based on current, real-time data in order to provide an up-to-date replica of entity computing system 120. In some examples, artificial intelligence may be used to capture the real-time data and synchronize the digital twin to the entity computing system 120. In some arrangements, the digital twin may operate with continuous synchronization, ensuring that the digital twin accurately reflects the live system, including network traffic, configurations, and policies.

In some examples, digital twin computing platform 110 may continuously or near continuously receive real-time data from entity computing system 120 and/or other systems, such that the digital twin is continuously or near continuously being updated and/or synchronized with new or current data. Accordingly, the digital twin may continuously mirror the live or deployed system or environment, including configurations, network traffic, system updates, and the like. Further, in some examples, the machine learning model may be executed each time new or updated data is received, thereby providing updated, current insights for the most recent real-time data. Accordingly, one or more of steps 205 through 208 may be performed continuously or in a loop in order to maintain an updated digital twin.

At step 209, in some examples, digital twin computing platform 110 may generate a honeypot or other lure for unauthorized actors. For instance, the digital twin of entity computing system 120 may be made available such that it appears to be the deployed version of entity computing system 120. In some examples, one or more protections used with the deployed version of entity computing system 120 (e.g., firewalls or the like) may be limited or removed in order to make it easier for unauthorized actors to engage with the digital twin of the entity computing system 120. In some arrangements, the honeypot may include providing the digital twin with false or imposter data that may appear to be authentic data (e.g., user personal identifying information, account numbers, geo-location data, or the like) but are, in-fact, imposter data used to lure the unauthorized actors to the honeypot.

At step 210, digital twin computing platform 110 may capture data related to the honeypot. For instance, if an unauthorized user is detected, data associated with the unauthorized user (e.g., IP address, technique used to access the digital twin, types of data being viewed or downloaded by the unauthorized user, and the like) may be captured by the digital twin computing platform 110. The data may be used to analyze, trace or track, and the like, the unauthorized user and implement or develop additional cybersecurity measures to avoid attacks of the deployed version of the entity computing system 120. In some examples, the digital twin computing platform 110 may deploy one or more additional imitation or mock networks or systems to further confused the unauthorized actor.

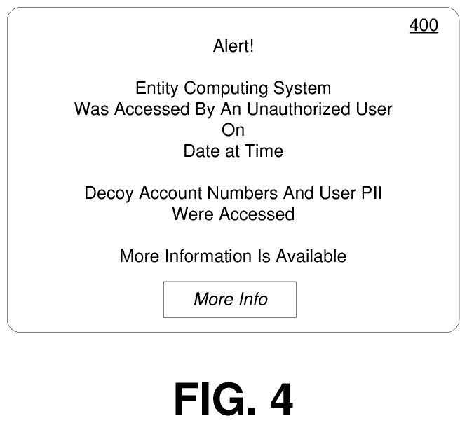

With reference to FIG. 2C, at step 211, digital twin computing platform 110 may generate an interface, dashboard, or the like, including information captured via the honeypot. For instance, FIG. 4 illustrates one example interface 400 that may be generated. It includes identification of the system associated with the digital twin accessed by the unauthorized user, time and date of the access, types of data viewed or downloaded, and the like. In some examples, a selectable option to view additional data may be provided via the interface 400. The additional data may include further information about techniques used to access the system, and the like.

Referring back to FIG. 2C, at step 212, digital twin computing platform 110 may transmit or send the interface to entity computing device 130. In some examples, transmitting or sending the interface may cause the entity computing device 130 to display the interface on a display of entity computing device 130.

At step 213, entity computing device 130 may receive and display the interface sent by the digital twin computing platform 110.

At step 214, in some examples, digital twin computing platform 110 may capture one or more snapshots of the digital twin of the entity computing system 120. For instance, a snapshot of the digital twin may be captured upon detection of a triggering event, at predetermined time intervals (e.g., each day, every 8 hours, or the like), or at other times. The snapshot may be stored by the digital twin computing platform 110 and may be used to recreate the entity computing system 120 in case or failure or other catastrophic event.

At step 215, digital twin computing platform 110 may execute one or more testing protocols on the digital twin of the entity computing system 120. For instance, digital twin computing platform 110 may execute one or more simulations, changes to configurations of the system, or the like, in the isolated, sandbox environment of the digital twin in order to simulate or measure impact on the deployed version of the entity computing system 120 but without disrupting the deployed version of the entity computing system 120. For instance, firewall rules and/or intrusion prevention system updated may be simulated by or executed on the digital twin before deployment in order to detect potential conflicts and validate effectiveness.

In another example, simulated cyber attached may be executed by the digital twin. For instance, distributed denial-of-service (DDoS) attacks, malware infections, lateral movement scenarios, and the like, may be executed on the digital twin of the entity computing system 120 to test the cyber defenses of the system and identify any gaps in protection.

In yet another examples, the digital twin may test high-stress scenarios, such as traffic overloads or node failures, to measure network performance and identify bottlenecks under heavy loads. In some examples, artificial intelligence or machine learning may be used to evaluate the data and provide insights.

Various other testing may be executed by the digital twin computing platform 110 without departing from the invention.

With reference to FIG. 2D, at step 216, digital twin computing platform 110 may generate one or more testing outcomes based on the tests executed by the digital twin. The testing outcomes may indicate potential areas of concern, where defenses should be bolstered, whether changes to one or more configurations should be made, whether any conflicts occurred during simulation, and the like.

At step 217, digital twin computing platform 110 may transmit or send the testing outcomes to the entity computing device 130. In some examples, transmitting or sending the testing outcomes to the entity computing device 130 may cause the testing outcomes to be displayed by a display of the entity computing device 130.

At step 218, entity computing device 130 may receive and display the testing outcomes.

At step 219, digital twin computing platform 110 may update and/or validate the machine learning model. For instance, based on captured honeypot data, testing outcomes, and the like, the machine learning model may be updated or validated to continuously improve accuracy of the insights output by the machine learning model.

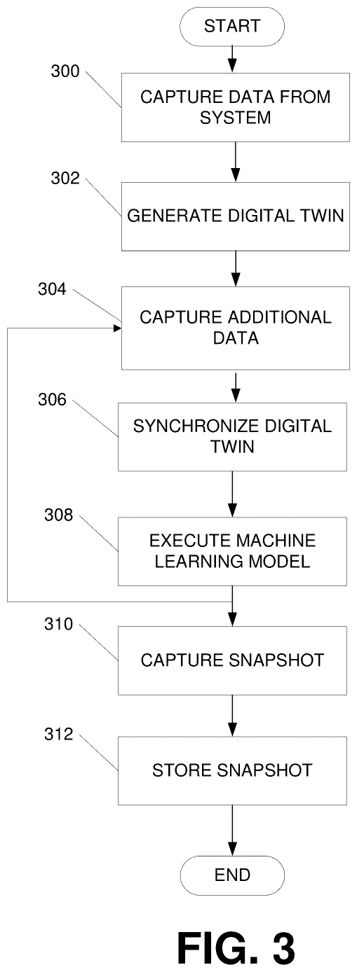

FIG. 3 is a flow chart illustrating one example method of generating a digital twin for network and system resilience in accordance with one or more aspects described herein. The processes illustrated in FIG. 3 are merely some example processes and functions. The steps shown may be performed in the order shown, in a different order, more steps may be added, or one or more steps may be omitted, without departing from the invention. In some examples, one or more steps may be performed simultaneously with other steps shown and described. One of more steps shown in FIG. 3 may be performed in real-time or near real-time.

At step 300, digital twin computing platform 110 may capture and/or receive data from an enterprise system or network, such as entity computing system 120. The data may include data related to all aspects of the system or network.

At step 302, based on the captured data, digital twin computing platform 110 may generate a digital twin of the entity computing system 120. For instance, digital twin computing platform 110 may generate a virtualized replica of entity computing system 120 in a secure environment.

At step 304, digital twin computing platform 110 may capture additional data from the enterprise system in real-time. For instance, in some examples, digital twin computing platform 110 may continuously or near continuously capture additional, real-time data from the enterprise system (e.g., entity computing system 120).

At step 306, digital twin computing platform 110 may continuously synchronize the digital twin with the enterprise system (e.g., entity computing system 120) based on the captured additional real-time data.

At step 308, digital twin computing platform 110 may execute a machine learning model. For instance, the additional, real-time data may be input to the machine learning model and the machine learning model may be executed to output one or more insights or recommendations related to the enterprise system or network (e.g., entity computing system 120).

In some examples, the process may continue to executed one or more of steps 304-308 in a loop to ensure the digital twin is maintained with current data and additional insights are generated based on current data.

At step 310, digital twin computing platform 110 may capture a snapshot of the digital twin at a predetermined time. In some examples, capturing the snapshot may be performed on a predetermined schedule (e.g., every 8 hours, once per day, or the like). In some arrangements, capturing the snapshot of the digital twin may include overwriting a previous snapshot of the digital twin captured at an earlier point in time.

At step 312, digital twin computing platform 110 may store the captured snapshot. In some examples, upon detection of a failure of the enterprise network or system, digital twin computing platform 110 may retrieve the snapshot and restore the enterprise network or system based on the snapshot of the digital twin.

In some examples, digital twin computing platform 110 may further generate a honeypot based on the digital twin and capture data related to unauthorized actors detected accessing the honeypot. Additionally or alternatively, digital twin computing platform 110 may execute one or more testing processes on the digital twin. The testing processes may include testing implementation of new firewall rules or intrusion prevention system updated. In some examples, the testing processes may include simulated cyber attacks such as DDoS attacks, malware infections or lateral movement updates.

Accordingly, aspects described herein are directed to use of a digital twin for system or network testing and resilience. The arrangements described enable generation of a near complete duplicate of a system or network for executing different testing exercises, fail over in case of outage, and the like.

In some examples, artificial intelligence and/or machine learning may be used to continuously capture the real-time data of the system or network in order to continuously synchronize the digital twin with the enterprise network or system. This may enable the digital twin to be as close to a real-time replica of the enterprise network or system as possible. The digital twin may, in some examples, provide a minute-to-minute replica of the current system or network conditions, with constant, ongoing checks in place.

As discussed herein, the digital twin may be used to test threat assessments, run threat assessments against the digital twin to identify vulnerabilities, and the like to test network or system resilience. By leveraging sandboxing capabilities, a secure testing environment may be provided where changes, updates and potential threats can be safely evaluated.

In some examples, as discussed above, a machine learning model may be used to analyze data and identify one or more insights or recommendations. In some examples, if the machine learning model identifies a potential breach, the computing platform may automatically reroute how data is transmitted in order to mitigate damage.

In some arrangements, one or more snapshots of different states of the network or system may be captured. In some examples, artificial intelligence may be used to capture and/or maintain data points and, when an issue is detected, identify a safe recovery point for the system or network. In some examples, the snapshots may be captured on a regular basis or schedule. Additionally or alternatively, artificial intelligence may be used to identify optimal operation of the system or network and capture a snapshot at that time. For instance, artificial intelligence may be used to detect variables at an optimal performance for the network or system and capture a snapshot at that time. Accordingly, the snapshots may be of the network or system in an optimized state or condition. In some examples, a threshold level of performance may be used to determine when to capture one or more snapshots. For instance, if performance of the network or system is at least 95%, 97%, 99% or the like, of optimal performance, a snapshot may be captured.

The data captured and used to synchronize the digital twin may be stored for a predetermined time period (e.g., one month, three months, or the like). In some examples, upon expiration of that time period, the data may be overwritten with current data. Additionally or alternatively, if no issues are detected during that time period (e.g., no indicators of compromise), the data may be overwritten. However, if one or more issues or potential issues are detected, the data may be moved or transferred to a data archive or off-site storage location to preserve the data for further analysis.

In some examples, if unusual behavior or potential issues are detected, the data may be flagged for further analysis and one or more analysts may review the data to determine whether an actual issue occurred or if there is a false positive. The output from the analyst review may be used to update, validate or retrain the machine learning model to further improve accuracy in detecting potential issues.

Further, aspects described herein may be used in disaster recovery. Conventional systems for disaster recovery are often reactive and lack the infrastructure to test failover strategies without disrupting live systems. The arrangements described herein periodically generate snapshots of the digital twin (e.g., snapshots or network or system states captured from the digital twin), enabling enterprise organizations to test disaster recovery strategies and measure system resilience under simulated stress without disrupting operations. The snapshots may serve as a baseline for failover and can be used for automated recovery in the event of disruptions. The digital twin may be used to test failover mechanisms and evaluate recovery time objectives to ensure minimal downtime during disruptions or failures.

In some examples, the machine learning model may continuously analyze potential threats to the enterprise network or system based on detected anomalies in the digital twin. Detected suspicious patterns or anomalies in the digital twin may enhance identification of hidden vulnerabilities or advanced persistent threats.

Further, the arrangements described herein may seamlessly integrate with existing network monitoring, threat detection, and other security tools to improve security visibility for the enterprise organization.

In some examples, one or more notifications, interfaces, dashboards, or the like, may be generated based on the digital twin. In some examples, those notifications, interfaces, dashboard, or the like, may include visualized dependencies between network nodes, system and/or services to enable the enterprise organization to assess the impact of changes before implementing them.

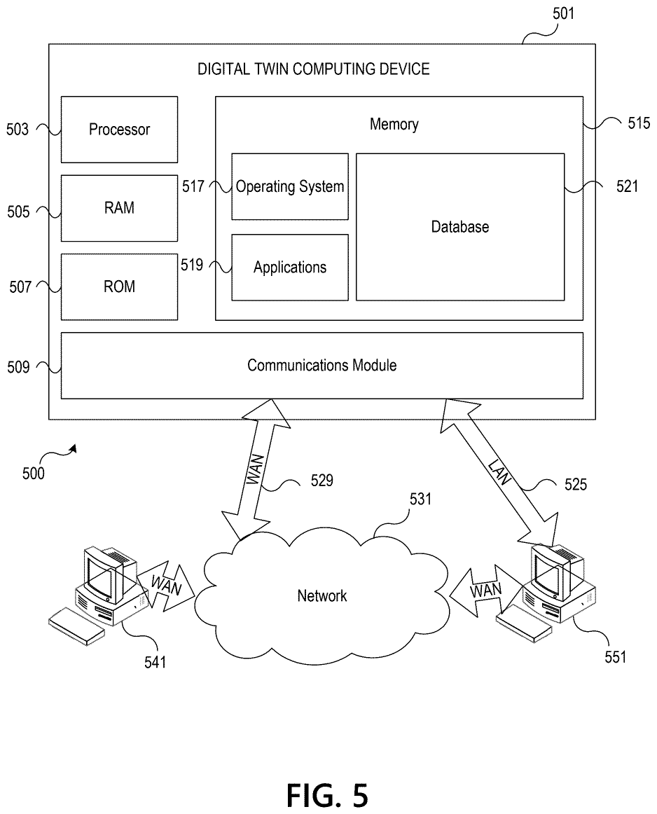

FIG. 5 depicts an illustrative operating environment in which various aspects of the present disclosure may be implemented in accordance with one or more example embodiments. Referring to FIG. 5, computing system environment 500 may be used according to one or more illustrative embodiments. Computing system environment 500 is only one example of a suitable computing environment and is not intended to suggest any limitation as to the scope of use or functionality contained in the disclosure. Computing system environment 500 should not be interpreted as having any dependency or requirement relating to any one or combination of components shown in illustrative computing system environment 500.

Computing system environment 500 may include digital twin computing device 501 having processor 503 for controlling overall operation of digital twin computing device 501 and its associated components, including Random Access Memory (RAM) 505, Read-Only Memory (ROM) 507, communications module 509, and memory 515. Digital twin computing device 501 may include a variety of computer readable media. Computer readable media may be any available media that may be accessed by digital twin computing device 501, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by digital twin computing device 501.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor (e.g., hardware processor) on digital twin computing device 501. Such a processor may execute computer-executable instructions stored on a computer-readable medium.

Software may be stored within memory 515 and/or storage to provide instructions to processor 503 for enabling digital twin computing device 501 to perform various functions as discussed herein. For example, memory 515 may store software used by digital twin computing device 501, such as operating system 517, application programs 519, and associated database 521. Also, some or all of the computer executable instructions for digital twin computing device 501 may be embodied in hardware or firmware. Although not shown, RAM 505 may include one or more applications representing the application data stored in RAM 505 while digital twin computing device 501 is on and corresponding software applications (e.g., software tasks) are running on digital twin computing device 501.

Communications module 509 may include a microphone, keypad, touch screen, and/or stylus through which a user of digital twin computing device 501 may provide input, and may also include one or more of a speaker for providing audio output and a video display device for providing textual, audiovisual and/or graphical output. Computing system environment 500 may also include optical scanners (not shown).

Digital twin computing device 501 may operate in a networked environment supporting connections to one or more remote computing devices, such as computing devices 541 and 551. Computing devices 541 and 551 may be personal computing devices or servers that include any or all of the elements described above relative to digital twin computing device 501.

The network connections depicted in FIG. 5 may include Local Area Network (LAN) 525 and Wide Area Network (WAN) 529, as well as other networks. When used in a LAN networking environment, digital twin computing device 501 may be connected to LAN 525 through a network interface or adapter in communications module 509. When used in a WAN networking environment, digital twin computing device 501 may include a modem in communications module 509 or other means for establishing communications over WAN 529, such as network 531 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A computing platform, comprising:
at least one processor;
a communication interface communicatively coupled to the at least one processor; and
a memory storing computer-readable instructions that, when executed by the at least one processor, cause the computing platform to:
capture data from an enterprise system;
generate a digital twin of the enterprise system based on the captured data;
capture additional data from the enterprise system in real-time;
continuously synchronize the digital twin with the enterprise system based on the captured additional data from the enterprise system;
at a predetermined time, capture a snapshot of the digital twin; and
store the snapshot of the digital twin.

2. The computing platform of claim 1, further including instructions that, when executed, cause the computing platform to:
generate a honeypot based on the digital twin;
detect, based on the honeypot, unauthorized access to the digital twin; and
capture, based on the unauthorized access, data associated with an unauthorized user accessing the digital twin.

3. The computing platform of claim 1, further including instructions that, when executed, cause the computing platform to:
detect a failure of the enterprise system;
responsive to detecting the failure, retrieve the snapshot of the digital twin; and
restore the enterprise system based on the snapshot of the digital twin.

4. The computing platform of claim 1, wherein capturing the snapshot of the digital twin is performed on a predetermined schedule.

5. The computing platform of claim 1, wherein capturing the snapshot of the digital twin includes overwriting a previous snapshot of the digital twin captured at an earlier point in time.

6. The computing platform of claim 1, further including instructions that, when executed, cause the computing platform to:
execute one or more testing processes on the digital twin; and
capture results of the testing processes executed by the digital twin.

7. The computing platform of claim 6, wherein executing the one or more testing processes on the digital twin is performed in a sandbox environment.

8. The computing platform of claim 6, wherein the one or more testing processes include one or more of: testing of new firewall rules or testing of intrusion prevention system updates.

9. The computing platform of claim 6, wherein the one or more testing processes include simulated cyber attacks.

10. The computing platform of claim 9, wherein the simulated cyber attacks include one or more of: distributed denial-of-service (DDoS) attacks, malware infections or lateral movement updates.

11. A method, comprising:
capturing, by a computing platform, the computing platform having at least one processor, and memory, data from an enterprise system;
generating, by the at least one processor, a digital twin of the enterprise system based on the captured data;
capturing, by the at least one processor, additional data from the enterprise system in real-time;
continuously synchronizing, by the at least one processor, the digital twin with the enterprise system based on the captured additional data from the enterprise system;
at a predetermined time, capturing, by the at least one processor, a snapshot of the digital twin; and
storing, by the at least one processor, the snapshot of the digital twin.

12. The method of claim 11, further including:
generating, by the at least one processor, a honeypot based on the digital twin;
detecting, by the at least one processor and based on the honeypot, unauthorized access to the digital twin; and
capturing, by the at least one processor and based on the unauthorized access, data associated with an unauthorized user accessing the digital twin.

13. The method of claim 11, further including:
detecting, by the at least one processor, a failure of the enterprise system;
responsive to detecting the failure, retrieving, by the at least one processor, the snapshot of the digital twin; and
restoring, by the at least one processor, the enterprise system based on the snapshot of the digital twin.

14. The method of claim 11, wherein capturing the snapshot of the digital twin is performed on a predetermined schedule.

15. The method of claim 11, wherein capturing the snapshot of the digital twin includes overwriting a previous snapshot of the digital twin captured at an earlier point in time.

16. The method of claim 11, further including:
executing, by the at least one processor, one or more testing processes on the digital twin; and
capturing, by the at least one processor, results of the testing processes executed by the digital twin.

17. The method of claim 16, wherein the one or more testing processes include one or more of: testing of new firewall rules or testing of intrusion prevention system updates.

18. The method of claim 16, wherein the one or more testing processes include simulated cyber attacks.

19. The method of claim 18, wherein the simulated cyber attacks include one or more of: distributed denial-of-service (DDoS) attacks, malware infections or lateral movement updates.

20. One or more non-transitory computer-readable media storing instructions that, when executed by a computing platform comprising at least one processor, memory, and a communication interface, cause the computing platform to:
capture data from an enterprise system;
generate a digital twin of the enterprise system based on the captured data;
capture additional data from the enterprise system in real-time;
continuously synchronize the digital twin with the enterprise system based on the captured additional data from the enterprise system;
at a predetermined time, capture a snapshot of the digital twin; and
store the snapshot of the digital twin.
